(19) United States
(12) Patent Application Publication
(10) Pub. No.: US 2011/0263150 A1
(43) Pub. Date: Oct. 27, 2011

(54) SHIELD CASE AND CONNECTOR HAVING THE SAME

(75) Inventors: Daisuke SASAKI, Yao-shi (JP); Junichi Arai, Isesaki-shi (JP)

(73) Assignee: HOSIDEN CORPORATION, Yao-shi (JP)

(21) Appl. No.: 13/082,614

(22) Filed: Apr. 8, 2011

(30) Foreign Application Priority Data
Apr. 27, 2010 (JP) 2010-101767

(51) Int. Cl. H01R 13/62; H01R 13/648

(52) U.S. Cl. 439/345; 439/607.01; 439/607.34; 439/607.23

(57) ABSTRACT

The invention provides a shield case to cover a body, the body having a main body and first and second connecting portions projecting from the main body and lying adjacent to each other along a first direction. The shield case includes first to forth conductive shells. The first and second shells cover an outer circumference of the main body; the third shell covers the first connecting portion; and the fourth shell covers the second connecting portion. The third shell is in contact with at least one of the first and second shells. The first or fourth shell is in contact with the second shell. The fourth shell is provided integrally with the first shell and is adjacent to the third shell along the first direction. The first or fourth shell may not contact the second shell if the third shell is contactable with both the first and second shells.

The present application claims priority under 35 U.S.C. §119 of Japanese Patent Application Nos. 2010-101767 filed on Apr. 27, 2010, the disclosure of which is expressly incorporated by reference herein in their entity.

### BACKGROUND OF THE INVENTION

1. Technical Field

The present invention relates to connectors having two adjacent connecting portions, and particularly to a shield cases of the same connectors.

2. Background Art

A conventional plug connector of this type includes a body having a main body and first and second connecting portions, first and second metal shells covering an outer circumference of the main body, and a tuboid third metal shell covering outer circumferences of the first and second connecting portions, as disclosed in paragraph 0021 and FIG. 5 of Patent Literature 1. The plug connector may be connectable with a receptacle connector including a tuboid metal shell having an internal space partitioned into first and second slots with a bent portion formed by bending a central portion of a bottom plate of the metal shell toward a top plate. The first and second slots of the receptacle are adapted to fittingly receive the first and second connecting portions of the plug connector. A clearance is provided between the bent portion and the top plate of the metal shell of the receptacle connector so that the first and second slots partially communicate with each other. To avoid interference with the bent portion, the third metal shell of the plug connector is configured such that a central portion of a bottom plate is bent so as to contact a top plate.

Another conventional receptacle connector is configured such that the bent portion of the metal shell abuts the top plate, without clearance between the bent portion and the top plate, in other words, the first and second slots are completely partitioned with the bent portion. To be compatible with such a receptacle connector without interfering with its bent portion, the above plug connector may be modified to replace the third metal shell with fourth and fifth tuboid metal shells to cover circumferences of the first and second connecting portions.

Citation List

Patent Literature 1: Japanese Unexamined Patent Publication No. 2009-277497

### SUMMARY OF INVENTION

Unfortunately, the plug connector including the first, second, fourth and fifth metal shells would have increased number of components, fabricated in increased assembling man-hours and therefore at increased cost. Moreover, the first, second, fourth and fifth metal shells of the plug connector need to be electrically connected to one another to address electro-magnetic interference (EMI). The time and manpower for electrically connecting the four metal shells would further increase the cost of the plug connector.

The present invention has been devised in view of the above-described situation. The present invention provides a shield case and a connector that are compatible with a mating connector with completely partitioned first and second slots, that can be fabricated with reduced number of components and in reduced assembling man-hours, and that have shells adapted for easy electric connection therebetween.

In order to solve the above-described problem, the invention provides a shield case to cover a body, the body having a main body and first and second connecting portions projecting from the main body and lying adjacent to each other along a first direction. The shield case includes: first and second shells, having conductive properties and being adapted to cover an outer circumference of the main body; a third shell, having a conductive property and being adapted to cover the first connecting portion; and a fourth shell, having a conductive property and being adapted to cover the second connecting portion. The third shell is in contact with at least one of the first and second shells. The first or fourth shell is in contact with the second shell. The fourth shell is provided integrally with the first shell and is adjacent to the third shell along the first direction. The first or fourth shell may not be contactable with the second shell if the third shell is contactable with both the first and second shells.

In the above-described shield case, the fourth shell is provided integrally with the first shell, so that it is possible to reduce the number of components and further reduce the assembling man-hours of a connector having the present shield case, compared with the above conventional connectors. Moreover, as the fourth shell is integrated with the first shell, electrical connection between the first, second, third and fourth shells can be established with ease, simply by bringing the first or fourth shell into contact with the second shell and bringing the third shell into contact with at least one of the first and second shells, or alternatively, by bringing the third shell into contact with both the first and second shells. The invention can thus facilitate the electrical connection between the shells, compared with the conventional connector with four shells that need to be brought into contact with one another. Moreover, as the third and fourth shells are provided independently for covering the first and second connecting portion, respectively, a connector including the present shield case is adapted to mate with a connector with completely partitioned first and second slots. Furthermore, the fourth shell integrated with the first shell should have an improved prying resistance.

The first and second shells may each include a base, the base including first and second ends in the first direction and first and second ends in a second direction perpendicular to the first direction. The third shell may include: a shell body of tuboid shape, adapted to cover the first connecting portion; and a contact portion, being provided in the shell body and in contact with the first end in the second direction of the base of at least one of the first and second shells. The fourth shell may include: a shell body, adapted to cover the second connecting portion; and a joining portion, joining the shell body of the forth shell and the first end in the second direction of the base of the first shell. In this aspect of invention, electrical connection can be established with ease between the third shell and at least one of the first and second shells, simply by covering the first connecting portion with the shell body of the third shell and bringing the contact portion into contact with the first end in the second direction of at least one of the first and second shells. This configuration also facilitates electrical connection between the shells.

If the main body of the body includes first and second surfaces that are opposed along a third direction perpendicular to the first and second directions, at least one of the first and second shells may further include first and second side walls. The first and second side walls may stand upright at the first and second ends in the first direction of the base of the at least one of the first and second shells. The base of the first shell may be abuttable on the first surface of the main body. The base of the second shell may be abuttable on the second surface of the main body. This aspect of the invention can facilitate assembly of a connector including the present shield case. More particularly, the first and second shells can cover the outer circumference of the main body of the body, simply by bringing the bases of the first and second shell into abutment with the first and second surfaces of the main body of the body.

The fourth shell may further include a contact portion provided at the shell body. The contact portion may be in contact with the first end in the second direction of the second shell. In this aspect of the invention, electrical connection of the first and fourth shells to the second shell can be established with ease, simply by bringing the contact portion of the fourth shell into contact with the first end in the second direction of the second shell. This aspect of the invention also facilitates the electrical connection between the shells.

The shield case may include a first locking piece, provided on one side in the first direction of the fourth shell; and a second locking piece, provided on the other side in the first direction of the fourth shell. In this aspect of the invention, the first and second locking pieces as locked by the counterpart connector can maintain a state where the first and second connecting portions and the third and fourth shells are fitted in the first and second slots of the mating connector.

The first and second locking pieces may preferably be provided integrally with the first or second shell. In this aspect of the invention, the shield case with the first and second locking pieces can still be fabricated with a reduced number of components because the first and first and second locking pieces are integrated with the first or second shell. A connector including the present shield case can also be fabricated in reduced assembling man-hours.

The shield case may further include a first release lever, connecting between the first or second shell and the first locking piece; and a second release lever, connecting between the first or second shell and the second locking piece. The first or second shell may include first and second ends in the first direction, first and second ends in a second direction perpendicular to the first direction, and first and second side walls provided at the first and second ends in the first direction. The first and second release levers may be arranged with clearances from the first and second side walls and are movable toward the first and second side walls. In this aspect of the invention, the first and second locking pieces can be disengaged from the counterpart connector simply by displacing the first and second release levers toward the first and second side walls of the first or second shell.

The second release lever may include a second folded-back portion, being provided integrally with the second end in the second direction of the first or second shell and folded back toward the first end in the second direction thereof; and a second arm, being provided integrally with the second folded-back portion and is disposed with a clearance from the second side wall, the second arm including first and second ends in the second direction. The first release lever may include a first folded-back portion, being provided integrally with the second end in the second direction of the first or second shell and folded back toward the first end in the second direction thereof, a first arm, being provided integrally with the first folded-back portion and is disposed with a clearance from the first side wall; and a bridge, extending from the first arm into a space formed between the third and fourth shells. The bridge may include a first end provided integrally with the first arm and a second end disposed in the space. The second locking piece may be provided integrally with the first end of the second arm, and the first locking piece may be provided integrally with the second end of the bridge.

In this aspect of the invention, the second release lever is provided integrally with the second end in the second direction of the first or second shell, and the second locking piece is provided integrally with the first end of the second arm of the second release lever. Moreover, the first release lever is provided integrally with the second end in the second direction of the first or second shell, and the first locking piece is provided integrally with the second end of the bridge of the first release lever. Therefore, the shield case with the first and second release levers can still be fabricated with a reduced number of components. A connector including the present shield case can also be fabricated in reduced assembling man-hours.

If the body includes a slit communicating with the space between the third and fourth shells, the second end of the bridge may be disposed inside the slit, instead of being disposed in the space between the third and fourth shells.

If the body includes a locking projection, a cut-away or a locking hole for locking the locking projection may be formed in at least one of the first, second, third and fourth shells. If the body includes a locking hole, a locking projection adapted to be locked in the locking hole may be provided on at least one of the first, second, third and fourth shells. In either case, the locking projection is adapted to be locked in the locking hole, so that at least one of the first, second, third, and fourth shells is locked to the body. It is therefore easy to fix and position the body with respect to the one of the shells.

If the fourth shell includes first and second end portions in the first direction and the first and second end portions include openings, the first and second locking pieces may be adapted to face first and second ends in the first direction of the second connecting portion of the body. In this aspect of the invention, the first and second end portions of the second connecting portion are covered and shielded by the first and second locking pieces facing the first and second end portions in the first direction of the second connecting portion of the body.

A first connector of the present invention includes the above-described shield case; the body, including the main body and the first and second connecting portions projecting from the main body and lying adjacent to each other along the first direction; a plurality of first contacts, arrayed in the first and connecting portion; and a plurality of second contacts, arrayed in the second and connecting portion.

If the first connector is a plug connector, the first connector may further include a circuit board, provided in the main body of the body and connected to the first and second contacts; a cable, including a board-connectable portion adapted to be connected to the circuit board; and first and second cases having insulating properties, the first and second cases in combination being adapted to cover the first and second shells. The first and second shells of the shield case may be adapted to cover, in addition to the main body of the body, the outer circumference of the circuit board and the board-connectable portion of the cable.

A second connector of the present invention includes the above-described shield case; the body, including the main body and the first and second connecting portions projecting from the main body and lying adjacent to each other along the first direction, a plurality of first contacts, arrayed in the first and connecting portion; and a plurality of second contacts, arrayed in the second and connecting portion.

If the second connector is a plug connector, the second connector may further include a circuit board, provided in the main body of the body and adapted for connection with the first and second contacts; a cable, including a board-connectable portion adapted to be connected to the circuit board; and first and second cases having insulating properties, the first and second cases in combination being adapted to cover the first and second shells. The first and second shells of the shield case may be adapted to cover, in addition to the main body of the body, the outer circumference of the circuit board and the board-connectable portion of the cable. The first or second case may include first and second operation buttons to displace the first and second release levers toward the first and second side walls of the first or second shell.

### BRIEF DESCRIPTION OF DRAWINGS

FIG. 1A is a schematic perspective view of a connector according to an embodiment of the present invention as seen from the front top right side; FIG. 1B is a schematic front view of the connector; and FIG. 10 is a schematic plan view of the connector with its second resin case removed.

FIGS. 2A to 2C are schematic views of a body of the connector attached with a circuit board, first and second contacts, and first, second, third and fourth shells, where FIG. 2A is a plan view, FIG. 2B is a bottom view, and FIG. 2C is a back view.

FIGS. 3A to 3C are schematic views of the body of the connector attached with the circuit board, the first and second contacts, and the first, second, third and fourth shells, where FIG. 3A is a perspective view as seen from the front top right side, FIG. 3B is a perspective view as seen from the front top left side, and FIG. 3C is a perspective view as seen from the back bottom right side.

FIGS. 4A to 4C are schematic views of the body of the connector attached with the first and second contacts and the circuit board, where FIG. 4A is a perspective view as seen from the front top right side, FIG. 4B is a perspective view as seen from the back top left side, and FIG. 4C is a perspective view as seen from the back bottom right side.

FIG. 5A is a schematic perspective view of the first and fourth shells of the connector as seen from the front top right side, and FIG. 5B is a schematic perspective view of the first and fourth shells as seen from the back top left side.

FIG. 6A is a schematic perspective view of the second shell of the connector as seen from the front top right side, and FIG. 6B is a schematic perspective view of the second shell as seen from the back top left side.

FIG. 7A is a schematic perspective view of the third shell of the connector as seen from the front top right side, and FIG. 7B is a schematic perspective view of the third shell as seen from the back top left side.

FIG. 8A is a schematic perspective view of a first resin case of the connector as seen from the back top left side, and FIG. 8B is a schematic perspective view of the second resin case of the connector as seen from the front bottom right side.

FIG. 9 is a schematic front view of a receptacle connector adapted for connection with the above-described connector.

### DESCRIPTION OF EMBODIMENTS

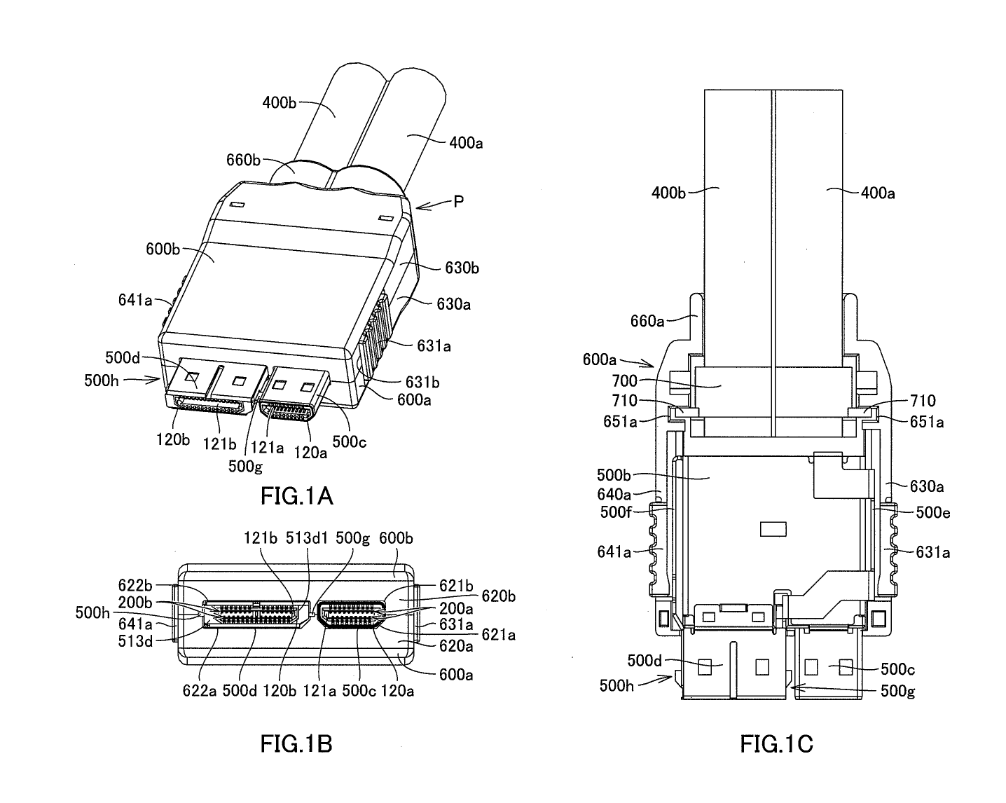

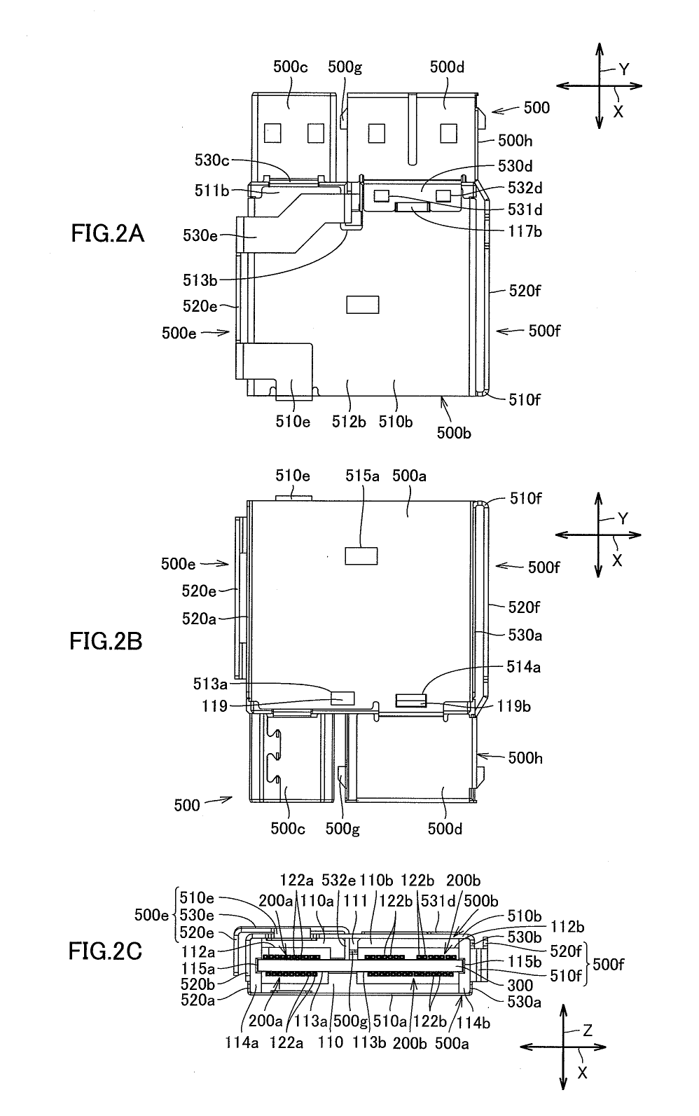

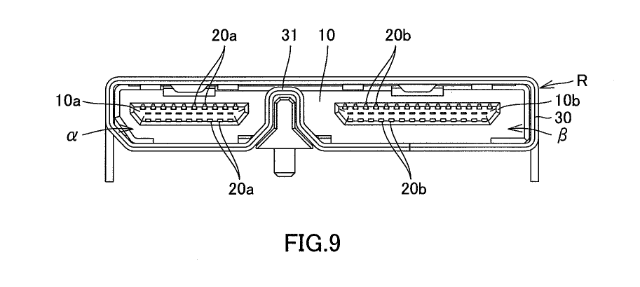

Hereinafter, a plug connector according to an embodiment of the present invention will be described with referent to FIGS. 1A to 9. The plug connector shown in FIGS. 1A to 3C (hereinafter referred to as a plug P) is a connector adapted for connection with a receptacle connector (hereinafter referred to as a receptacle R) such as one shown in FIG. 9. For convenience of explanation, FIGS. 2A to 8B shows a first direction X, a second direction Y perpendicular to the first direction, and a third direction Z perpendicular to the first and second directions.

The receptacle R includes a body 10, a plurality of contacts 20a, 20b, and a shell 30, as shown in FIG. 9. The shell 30 is a tuboid conductive metal for covering the body 10, and it has a top plate and a bottom plate. The bottom plate is bent at its center into a substantially U shape toward the top plate to form a bent portion 31. The bent portion 31 is in contact with the top plate of the shell 30. That is, the bent portion 31 partitions an internal space of the shell 30 completely into first and second slots α, β. First and second connection projections 10a, 10b project from the front surface of the body 10 into the first and second slots α, β. The contacts 20a are arrayed on upper and lower surfaces of the first connection projection 10a, and the contacts 20b are arrayed on upper and lower surfaces of the second connection projection 10b. The first slot α, the first connection projection 10a and the contacts 20a are configured to comply with the HDMI (High Definition Multimedia Interface; registered trademark) type D standard. The second slot β, the second connection projection 10b and the array of the contacts 20b are configured to comply with a standard other than HDMI standards. The second slot p have first and second locking holes (not shown) in opposite widthwise inner walls.

The plug P has a body 100, a plurality of first and second contacts 200a, 200b, a circuit board 300, first and second cables 400a, 400b, a shield case 500, and first and second resin cases 600a, 600b (first and second cases). The respective components of the plug P will be described in detail below.

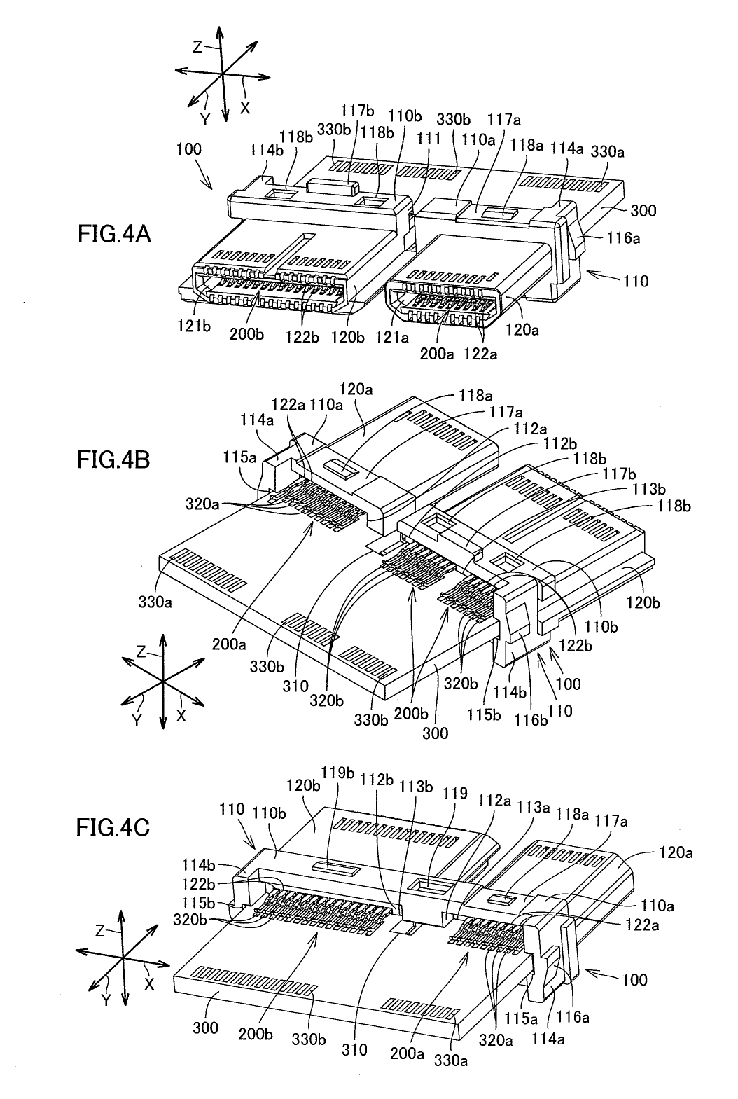

The first body 100 is an injection-molded article of insulating resin, as shown in FIGS. 4A to 4C. The body 100 has a main body 110, and first and second connecting portions 120a, 120b. The main body 110 is a substantially rectangular plate. From a front surface of the main body 110 the first and second connecting portions 120a, 120b project to lie adjacent to each other along the first direction X. The main body 110 has a slit 111 communicating with a space between the first and second connecting portions 120a, 120b. The slit 111 divides the main body 110 into first and second plates 110a, 110b.

Rear surfaces of the first and second plates 110a, 110b (i.e., of the main body 110) have generally rectangular depressions 112a, 112b as shown in FIGS. 2C, 4B and 4C. On the bottom of the depressions 112a, 112b, rectangular circuit board fitting holes 113a, 113b are centrally formed to fittingly receive first ends in the second direction Y of the circuit board 300. A pair of guide plates 114a, 114b extend in the second direction Y from the respective outer ends in the first direction X of the rear surfaces of the first and second plates 110a, 110b. Inner surfaces of the guide plates 114a, 114b have a pair of guide depressions 115a, 115b. The guide depressions 115a, 115b extend in the second direction Y to guide first and second end portions in the first direction X of the circuit board 300 to the circuit board fitting holes 113a, 113b. Moreover, outer surfaces of the guide plates 114a, 114b have a pair of locking projections 116a, 116b, respectively. The locking projections 116a, 116b are tapered down (gradually reduced in thickness) toward the top.

The circuit board 300, a well-known printed circuit board, is attachable to the body 100. The circuit board 300 has the first and second end portions in the first direction X and first and second end portions in the second direction Y. The first end portion in the second direction Y of the circuit board 300 has a slit 310 at a position corresponding to the slit 111. The slit 310 communicates with the slit 111. As shown in FIGS. 4B and 4C, a plurality of electrodes 320a, 320b are arranged on upper and lower surfaces of the first end portion in the second direction Y of the circuit board 300, particularly outside the slit 310. A plurality of electrodes 330a, 330b are arranged on upper and lower surfaces of the second end portions in the second direction Y of the circuit board 300. The electrodes 320a, 320b are connected to the electrodes 330a, 330b via conductive lines (not shown) provided in at least one of the upper surface, the lower surface, and an inner portion of the circuit board 300. The electrodes 330a, 330b are connected by soldering to cores of signal lines of the first and second cables 400a, 400b, respectively. The first and second cables 400a, 400b are well-known cables, each including the plurality of signal lines, an outer shield conductor covering the signal lines, and an external insulator made of vinyl chloride or the like covering the outer shield conductor. The signal lines each include the core, an inner shield conductor covering the core, and an internal insulator covering the inner shield conductor. The first and second cables 400a, 400b are attached to a clamp 700, as shown in FIG. 10. The clamp 700 has a pair of flanges 710. It should be appreciated that FIG. 10 illustrates the first and second cables 400a, 400b with distal ends of the signal lines exposed from the external insulators of the first and second cables 400a, 400b omitted. We hereinafter use a term “board-connectable portions” referring to the distal ends of the signal lines exposed from the external insulators of the first and second cables 400a, 400b, cores of which are connectable by soldering to the electrodes 330a, 330b.

As shown in FIGS. 4A to 4C, the first plate 110a has a pair of attaching depressions 117a in its upper and lower surfaces. The bottoms of the attaching depressions 117a are provided with a pair of locking projections 118a. The second plate 110b has a rectangular-parallelepiped locking projection 117b on its upper surface. A rectangular positioning hole 118b is formed on either side of the projection 117b, as shown in FIGS. 4A and 4B. The lower surface of the second plate 110b is provided with a locking projection 119b as shown in FIG. 4C. Front ends of the locking projections 118a and the locking projection 119b are tapered (gradually reduced in thickness) toward the front. Further, a rectangular positioning hole 119 is provided between the attaching depression 117a and the locking projection 119b in a lower surface of the main body 110.

The main body 110 and the first connecting portion 120a have a first connection hole 121a, as shown in FIG. 4A. The first connection hole 121a passes through from a front surface of the first connecting portion 120a to the bottom of the circuit board fitting hole 113a. The first connection hole 121a has an inner shape conforming to an outer shape of the first connection projection 10a of the receptacle R. Upper and lower surfaces of the first connection hole 121a are provided with a plurality of receiving grooves 122a for receiving the contacts 200a, as shown in FIGS. 2C and 4A. The receiving grooves 122a are arrayed in a corresponding manner to the array of the contacts 20a of the receptacle R. Rear ends of the receiving grooves 122a are open from the bottom of the depression 112a to the outside. Rear ends of the contacts 200a project out of the rear ends of the receiving grooves 122a so as to be connected by soldering to the electrodes 320a of the circuit board 300, as shown in FIGS. 4B and 4C. The contacts 200a are bent at their front end portions, and summits of the front end portions are located inside the first connection hole 121a. That is, when the first connection projection 10a of the receptacle R is inserted into the first connection hole 121a, the summits of the contacts 200a make contact with the contacts 20a of the receptacle R. In summary, the first connecting portion 120a, the first connection hole 121a, the receiving grooves 122a and the contacts 200a are configured to comply with the HDMI type D standard.

The main body 110 and the second connecting portion 120b have a second connection hole 121b, as shown in FIG. 4A. The second connection hole 121b passes through from a front surface of the second connecting portion 120b to the bottom of the circuit board fitting hole 113b. The second connection hole 121b has an inner shape conforming to an outer shape of the second connection projection 10b of the receptacle R. Upper and lower surfaces of the second connection hole 121b are provided with a plurality of receiving grooves 122b for receiving the contacts 200b, as shown in FIGS. 2C and 4A. The receiving grooves 122b are arrayed in a corresponding manner to the array of the contacts 20b of the receptacle R. Rear ends of the receiving grooves 122b are open from the bottom surface of the depression 112b to the outside. Rear ends of the contacts 200b project out of the rear ends of the receiving grooves 122b so as to be connected by soldering to the electrodes 320b of the circuit board 300, as shown in FIGS. 4B and 4C. As shown in FIG. 4A, the contacts 200b are bent at their front end portions, and summits of the front end portions are located inside the second connection hole 121b, as shown in FIG. 4A. That is, when the second connection projection 10b of the receptacle R is inserted into the second connection hole 121b, the summits of the contacts 200b make contact with the contacts 20b of the receptacle R. In summary, the second connecting portion 120b, the second connection hole 121b, the receiving grooves 122b, and the contacts 200b are configured to comply with a standard other than HDMI standards.

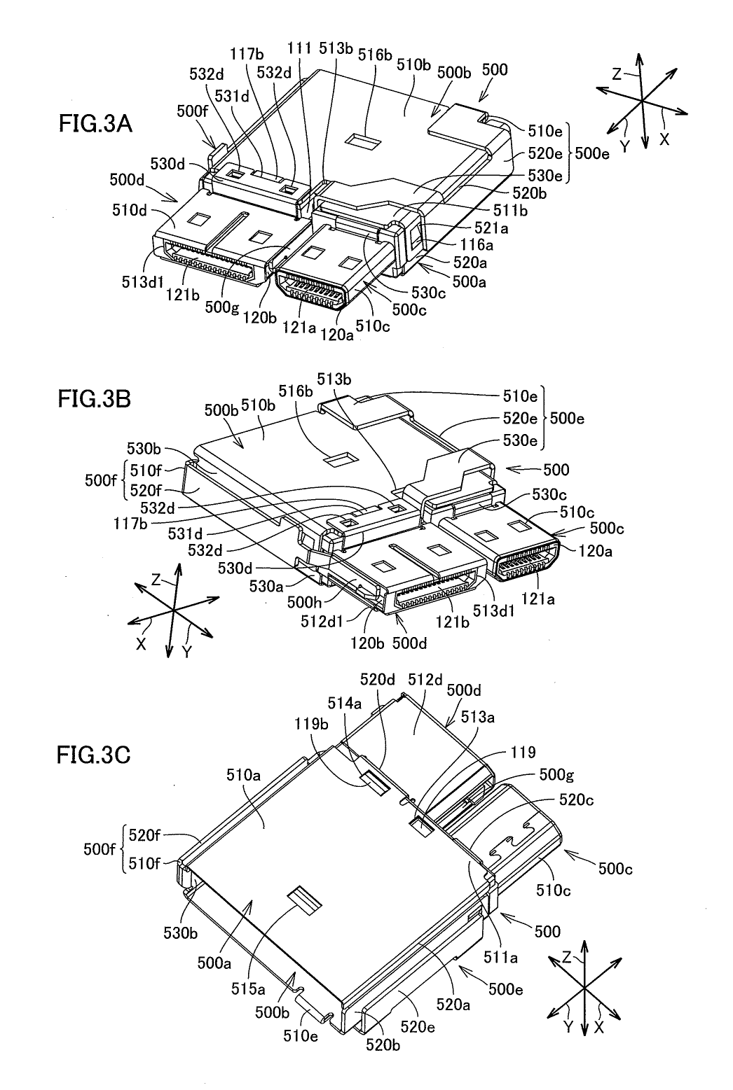

The shield case 500 is configured to cover the body 100, the circuit board 300 and board-connectable portions of the first and second cables 400a, 400b, as shown in FIG. 2C. As shown in FIGS. 2A to 3C, the shield case 500 has a shell 500a (first shell), a shell 500b (second shell), a shell 500c (third shell), a shell 500d (fourth shell), release levers 500e, 500f (first and second release levers), and latch pieces 500g, 500h (first and second locking pieces).

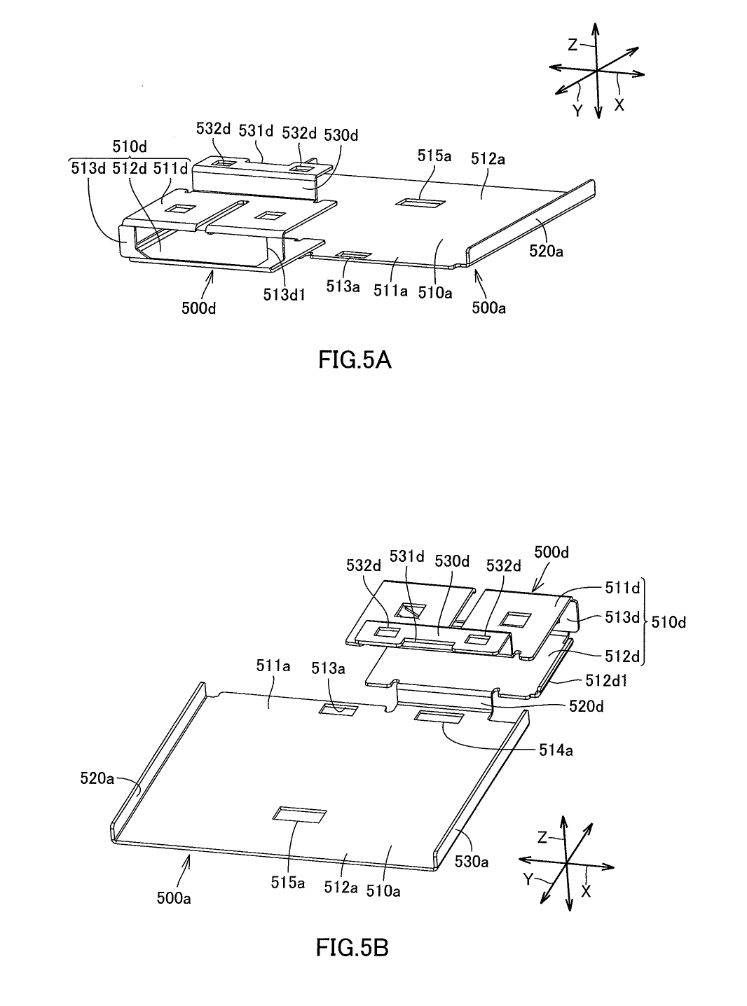

The shell 500a and the shell 500d are made of a sheet of conductive metal, as shown in FIGS. 5A and 5B. The shell 500a includes a rectangular base plate 510a (base) and rectangular side walls 520a, 530a (first and second side walls). The base plate 510a have first and second ends in the first direction X and first and second end portions 511a, 512a in the second direction Y. The side walls 520a, 530a stand upright at the first and second ends, respectively, in the first direction X of the base plate 510a. The side walls 520a, 530a abut lower portions of outer surfaces in the first direction X of the main body 110 of the body 100. The base plate 510a abuts the lower surface of the main body 110 of the body 100 (i.e., a first surface in the third direction Z of the main body 110). A length dimension in the second direction Y of the base plate 510a and the side walls 520a, 530a is larger than a length dimension from the front surface of the main body 110 to the second end in the second direction Y of the circuit board 300 as attached to the main body 110. The base plate 510a and the side walls 520a, 530a cover lower portions of the main body 110, the circuit board 300 and the board-connectable portion of the cable 400. As shown in FIG. 5B, the first end portion 511a has a positioning hole 513a and a locking hole 514a. The positioning hole 513a, having the same shape as the positioning hole 119, is formed at a position corresponding to the positioning hole 119 of the main body 110. The locking hole 514a is provided at a position corresponding to the locking projection 119b of the main body 110 and used to lock the locking projection 119b. An intermediate portion between the first and second end portions 511a, 512a of the base plate 510a also has a substantially rectangular positioning hole 515a.

The shell 500d includes a shell body 510b, a joining plate 520d (joining portion) and a contact plate 530d (contact portion). The shell body 510d has an upper plate 511d, a lower plate 512d, and a front plate 513d. As shown in FIGS. 3A and 3B, the upper plate 511d is a plate of a length dimension and a width dimension slightly larger than those of an upper surface of the second connecting portion 120b of the body 100. The upper plate 511d abuts and covers the upper surface of the second connecting portion 120b. The lower plate 512d is a plate of a length dimension slightly larger than that of a lower surface of the second connecting portion 120b of the body 100, and of a width dimension substantially the same as that of the lower surface. The lower plate 512d abuts and covers the lower surface of the second connecting portion 120b. As shown in FIG. 5B, the lower plate 512d is provided with an inclined plate 512d1 at its outer end in the first direction X. The inclined plate 512d1 extend along an inclined outer surface of the second connecting portion 120b. Moreover, the front plate 513d couples the upper plate 511d and the lower plate 512d at their first ends in the second direction Y and has an outer shape slightly larger than an outer shape of the front surface of the second connecting portion 120b. The front plate 513d abuts and covers the front surface of the second connecting portion 120b. The front plate 513d has an opening 513d1 not to block the second connection hole 121b of the second connecting portion 120b. Moreover, clearance is created between first ends and between second ends in the first direction X of the upper plate 511d and the lower plate 512d (i.e., first and second end portions in the first direction X of the shell body 510d are open) so as to expose first and second ends in the first direction X of the second connecting portion 120b. Outer shapes of the shell body 510d and the second connecting portion 120b each conform to an inner shape of the second slot β of the receptacle R. That is, the shell body 510d and the second connecting portion 120b are adapted to fit in the second slot β.

The joining plate 520d is a rectangular plate to connect a second end in the second direction Y of the lower plate 512d and the first end portion 511a of the base plate 510a, as shown in FIG. 5B. The joining plate 520d makes the shell 500d integral with the shell 500a. The contact plate 530d is a generally downward L-shaped plate continuing to a second end in the second direction Y of the upper plate 511d. An upper plate of the contact plate 530d has a generally rectangular cut-away 531d at a portion corresponding to the locking projection 117b of the main body 110. The locking projection 117b is fitted and locked in the cut-away 531d from the back side. On either side of the cut-away 531d of the upper plate of the contact plate 530d, there is formed a positioning hole 532d of the same shape as that of each positioning hole 118b of the main body 110, at positions corresponding to the positioning holes 118b. The positioning holes 532d communicate with the positioning holes 118b.

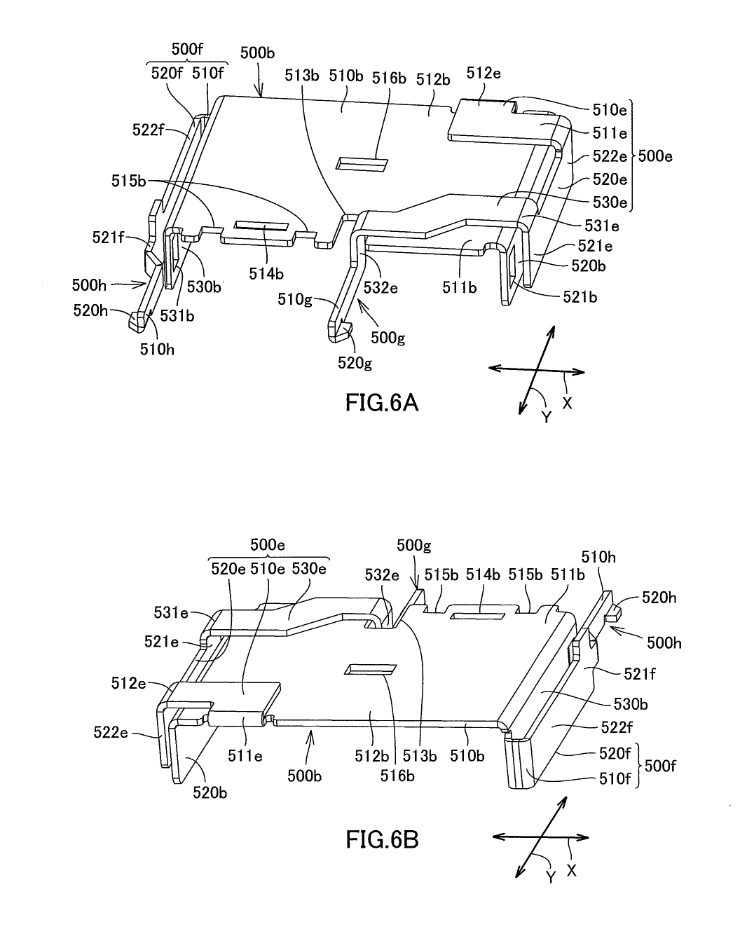

The shell 500b, the release levers 500e, 500f and the latch pieces 500g, 500h are made of a sheet of conductive metal, as shown in FIGS. 6A and 6B. The shell 500b includes a rectangular base plate 510b (base) and rectangular side walls 520b, 530b (first and second side walls). The base plate 510b have first and second ends in the first direction X and first and second end portions 511b, 512b in the second direction Y. The side walls 520b, 530b stand upright at the first and second ends, respectively, in the first direction X of the base plate 510b. The side walls 520b, 530b abut portions above the above-described lower portions of outer surfaces in the first direction X of the main body 110 of the body 100. The base plate 510b abuts the upper surface of the main body 110 of the body 100 (i.e., a second surface in the third direction Z of the main body 110). A length dimension in the second direction Y of the base plate 510b and the side walls 520b, 530b is larger than a length dimension from the front surface of the main body 110 to the second end in the second direction Y of the circuit board 300 as attached to the main body 110. That is, the base plate 510b and the side walls 520b, 530b cover upper portions excluding the above-mentioned lower portions of the main body 110, the circuit board 300 and the board-connectable portion of the cable 400.

The first end portion 511b has a slit 513b in its center, or at a position corresponding to the slit 111 of the main body 110. The slit 513b communicates with the slit 111 (refer to FIG. 3A). The upper plate of the contact plate 530d of the shell 500d is adapted to be placed on a portion on the left side (as shown in FIG. 6A) of the slit 513b of the first end portion 511b. In other words, the contact plate 530d is in contact with the left-hand portion of the first end portion 511b of the base plate 510b as shown in FIGS. 3A and 3B. This physical contact allows electrical connection between the shells 500a, 500d and the shell 500b. The above-described left-hand portion has a generally rectangular locking hole 514b at a portion corresponding to the locking projection 117b of the main body 110. The locking projection 117b is fitted and locked in the locking hole 514b. The left-hand portion is depressed on either side of the locking hole 514b to form a positioning hole 515b. The positioning holes 515b are located at positions corresponding to the positioning holes 118b of the body 110 and communicate with the positioning holes 532d of the shell 500d and the positioning holes 118b. Further, a positioning hole 516b is provided in the center of the base plate 510b. The side walls 520b, 530b each have first and second end portions in the second direction Y. The first end portions of the side walls 520b, 530b have rectangular locking holes 521b, 531b at positions corresponding to the locking projections 116a, 116b of the main body 110. The locking Projections 116a, 116b are adapted to be locked in the locking holes 521b, 531b.

The release lever 500e includes a folded-back portion 510a (first folded-back portion), an arm 520e (first arm) and a bridge 530e. The folded-back portion 510e has first and second end portions 511e, 512e in the second direction Y. The second end portion 512e is provided integrally with the second end portion 512b of the base plate 510b and folded back toward the first end portion 511b. The first end portion 511e extends from the second end portion 512e toward the side wall 520b. An end portion of the first end portion 511e is bent substantially at a right angle to extend along the side wall 520b. The arm 520e is a rectangular plate extending along the second direction Y and outside the side wall 520b with a clearance therebetween. The arm 520e has first and second end portions 521e, 522e in the second direction Y. The second end portion 522e is provided continuously to and integrally with the end portion of the first end portion 511e of the folded-back portion 510e. The bridge 530e, a substantially downward U-shaped plate, extends from the first end portion 521e of the arm 520e into the slit 513b of the base plate 510b and into the slit 111 of the main body 110. The bridge 530e has first and second end portions 531e, 532e in the first direction X. The second end portion 532e extends through the slit 111 into the slit 513b. The first end portion 531e is provided continuously to and integrally with the first end portion 521e of the arm 520e. The first end portion 531e is bent substantially at a right angle to the first end portion 521e. The bent portions of the first end portion 531e and the first end portion 511e are elastically deformable toward the side wall 520b, and such elastic deformation displaces the arm 520e from an initial position toward the side wall 520b. In accordance with the displacement of the arm 520e, the bridge 530e is displaced from an initial position in the same direction. As used herein, the “initial positions” of the arm 520e and the bridge 530e refer to a state where the arm 520e is substantially parallel to the side wall 520b.

The latch piece 500g includes an arm 510g extending in the second direction Y and a claw 520g provided at a distal end of the arm 510g. The arm 510g is provided continuously to and integrally with the second end portion 532e of the bridge 530e. The arm 510g is oriented to face the first end portion in the first direction X of the second connecting portion 120b with a clearance therebetween so as to cover this first end portion. The claw 520g is adapted to be locked in a first locking hole of the receptacle R. In accordance with the displacement of the arm 520e and the bridge 530e, the arm 510g and the claw 520g are displaced from initial positions toward the first end portion of the second connecting portion 120b, so that the claw 520g gets disengaged from the first locking hole of the receptacle R. As used herein, the “initial positions” of the arm 510g and the claw 520g refer to a state where the arm 520e is substantially parallel to the side wall 520b.

The release lever 500f includes a folded-back portion 510f (second folded-back portion) and an arm 520f (second arm). The folded-back portion 510f is provided integrally with the second end portion in the second direction Y of the side wall 530b, and it is folded back toward the first end portion in the second direction Y of the side wall 530b. The arm 520f is a rectangular plate extending in the second direction Y and lies outside the side wall 530b with a clearance therebetween. The arm 520f has first and second end portions 521f, 522f in the second direction Y. The second end portion 522f is provided continuously to and integrally with the folded-back portion 510f. The folded-back portion 510f is elastically deformable toward the side wall 530b, and such elastic deformation displaces the arm 520f from an initial position toward the side wall 530b. As used herein, the “initial position” of the arm 520f refers to a state where the arm 520f is substantially parallel to the side wall 530b.

The latch piece 500h includes an arm 510h extending in the second direction Y and a claw 520h provided at a distal end of the arm 510h. The arm 510h is provided continuously to and integrally with the first end portion 521f of the arm 520f. The arm 510h is oriented to face with a clearance the second end portion in the first direction X of the second connecting portion 120b so as to cover this second end portion. The claw 520h is adapted to be locked in a second locking hole of the receptacle R. In accordance with the displacement of the arm 520f of the release lever 500f, the arm 510h and the claw 520h are displaced from initial positions toward the second end portion of the second connecting portion 120b, so that the claw 520h gets disengaged from the second locking hole of the receptacle R. As used herein, the “initial positions” of the arm 510h and the claw 520h refer to a state where the arm 520f is substantially parallel to the side wall 530b.

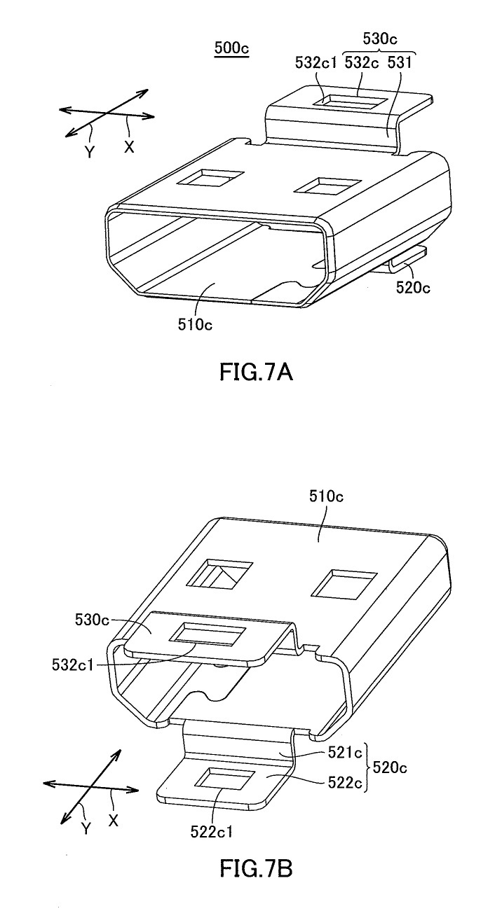

The shell 500c is made of a sheet of conductive metal. The shell 500c includes a shell body 510c and first and second contact plates 520c, 530c, as shown in FIG. 7A and 7B. The shell body 510c is a tuboid body to cover the outer circumference of the first connecting portion 120a. The shell body 510c and the first connecting portion 120a have outer shapes conforming to an inner shape of the first slot α and are adapted to fit in the second slot α. The first contact plate 520c is a substantially L-shaped plate provided continuously to a lower plate of the shell body 510c as shown in FIG. 7B, and the second contact plate 530c is a substantially L-shaped plate provided continuously to an upper plate of the shell body 510c as shown in FIG. 7A. The first and second contact plates 520c, 530c include first plates 521c, 531c, respectively, and second plates 522c, 532c, respectively, extending substantially at a right angle to the first plates 521c, 531c. The second plates 522c, 532c are adapted to fit in the attaching depressions 117a in the upper and lower surfaces, respectively, of the main body 110. The second plates 522c, 532c have rectangular locking holes 522c1, 532c1 at positions corresponding to the locking projections 118a on the bottom of the attaching depressions 117a. The locking projections 118a are fitted and locked in the associated locking holes 522c1, 532c1. The second plate 522c is in contact with the first end portion 511a of the base plate 510a of the shell 500a, as shown in FIGS. 3C. The second plate 532c is in contact with a portion on the right side (as shown in FIGS. 3A and 3B) of the slit 513b of the first end portion 511b of the base plate 510b of the shell 500b. These physical contacts allow electrical connection between the shells 500a to 500d.

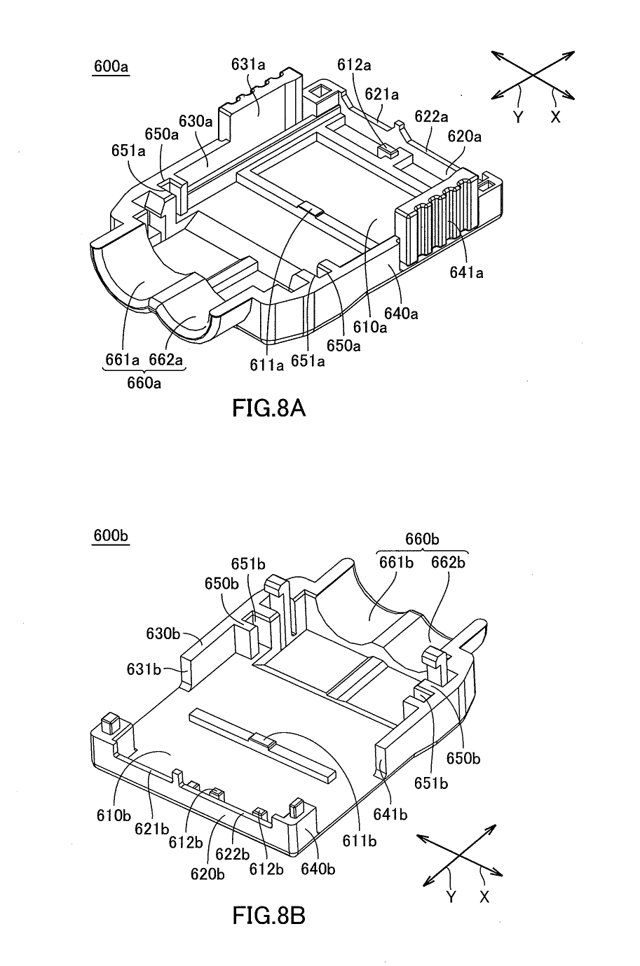

The first resin case 600a is an injection-molded article of insulating resin as shown in FIG. 8A. The first resin case 600a includes a bottom plate 610a, a front wall 620a, outer walls 630a, 640a, a pair of fixing portions 650a, and a lead-out portion 660a. In the bottom plate 610a, its first end portion in the second direction Y is provided with the front wall 620a standing upright, while its second end portion in the second direction Y is provided with the lead-out portion 660a. First and second end portions in the first direction X of the bottom plate 610a are provided with the outer walls 630a, 640a, respectively. Inside the outer walls 630a, 640a of the bottom plate 610a, there is provided the pair of fixing portions 650a. A space surrounded by the front wall 620a, the outer walls 630a, 640a, and the fixing portions 650a on the bottom plate 610a is used as an accommodating space to receive lower portions of the main body 110 of the body 100, the circuit board 300, and shells 500a, 500b and the release levers 500e, 500f of the shield case 500. An elongated protrusion extends along the first direction X in a central portion of the bottom plate 610a, and a substantially rectangular positioning projection 611a is provided centrally of the elongated protrusion. The positioning projection 611a is fittable into the positioning hole 515a of the shell 500a of the shield case 500 so as to position and fix the shield case 500 in the accommodating space. Another positioning projection 612a is provided near the front wall 620a of the bottom plate 610a. The positioning projection 612a is fittable into the positioning hole 513a of the shell 500a and the positioning hole 119 of the main body 110 so as to position and fix the shield case 500 in the accommodating space.

The front wall 620a has first and second depressions 621a, 622a adjacent to each other along the first direction X. The outer walls 630a, 640a are provided with operation buttons 631a, 641a, respectively (first and second operation buttons) at such positions as to face the arms 520e, 520f, respectively of the release levers 500e, 500f of the shield case 500, as shown in FIG. 10. When the operation buttons 631a, 641a press the arms 520e, 520f, the arms 520e, 520f are displaced inward (i.e., toward the walls 520b, 530b). The fixing portions 650a each have a slit 651a. The slits 651a are adapted to receive and position lower portions of the flanges 710 of the clamp 700. The lead-out portion 660a is configured to include two substantially semicircular arc-shaped depressions 661a, 662a in a continuous arrangement along the first direction X.

The second resin case 600b made of insulating resin is an upper case to be combined with the first resin case 600a, as shown in FIG. 8B. The second resin case 600b has a bottom plate 610b, a front wall 620b, outer walls 630b, 640b, a pair of fixing portions 650b, and a lead-out portion 660b. In the bottom plate 610b, its first end portion in the second direction Y is provided with the front wall 620b standing upright, while its second end portion in the second direction Y is provided with the lead-out portion 660b. First and second end portions in the first direction X of the bottom plate 610b are provided with the outer walls 630b, 640b. Inside the outer walls 630b, 640b of the bottom plate 610b, there is provided the pair of fixing portions 650b. A space surrounded by the front wall 620b, the outer walls 630b, 640b, and the fixing portions 650b on the bottom plate 610b is used as an accommodating space to receive upper portions of the main body 110 of the body 100, the circuit board 300, and shells 500a, 500b and the release levers 500e, 500f of the shield case 500. That is, the first and second resin cases 600a, 600b cover the main body 110, the circuit board 300, the shells 500a, 500b, and the release levers 500e, 500f. An elongated protrusion extends along the first direction X in a central portion of the bottom plate 610b, and a substantially rectangular positioning projection 611b is provided centrally of the elongated protrusion. The positioning projection 611b is fittable into the positioning hole 516b of the shell 500b of the shield case 500 so as to position and fix the shield case 500 in the accommodating space. A pair of rectangular column-shaped positioning projections 612b corresponding to the positioning holes 532d of the shield case 500 is provided near the front wall 620b of the bottom plate 610b, i.e., at positions corresponding to the positioning holes 532d. The positioning projections 612b are fittable into the pair of positioning holes 532d of the shell 500d, the positioning holes 515b of the shell 500b, and the positioning holes 118b of the main body 110 so as to position and fix the shield case 500 and the body 100 in the accommodating space.

The front wall 620b have first and second depressions 621b, 622b adjacent to each other along the first direction X. As shown in FIG. 1B, the first depression 621b is to be combined with the first depression 621a of the first resin case 600a to provide an opening to allow the first connecting portion 120a and the shell 500c covering the same to project therethrough to the outside. Similarly, the second depression 622b is to be combined with the second depression 622a of the first resin case 600a to provide an opening to allow the second connecting portion 120b and the shell 500d covering the same to project therethrough to the outside. The outer walls 630b, 640b, have loading depressions 631b, 641b for loading the operation buttons 631a, 641a at positions corresponding to the operation buttons 631a, 641a. The fixing portions 650b each have a slit 651b. The slits 651b are adapted to receive and position upper portions of the flanges 710 of the clamp 700. The lead-out portion 660b is configured to include two substantially semicircular arc-shaped depressions 661b, 662b in a continuous arrangement along the first direction X. The depression 661b is to be combined with the depression 661a of the first resin case 600a to provide a lead-out hole to lead out the first cable 400a. Similarly, the depression 662b is to be combined with the depression 662a of the first resin case 600a to provide a lead-out hole to lead out the second cable 400b.

The plug P having the above-described structure may be assembled in the steps as described below. The assembly steps include the steps to attach the shield case 500 to the body 100. The first step is to prepare the body 100. The contacts 200a, 200b are then inserted into the receiving grooves 122a, 122b of the body 100 from the rear side. Thereafter, the circuit board 300 is prepared with the electrodes 320a, 320b, 330a, 330b formed thereon. The circuit board 300 is inserted into the guide depressions 115a, 115b of the body 100. Using the guide depressions 115a, 115b to guide the first and second end portions in the first direction X of the circuit board 300, the circuit board 300 is further moved toward the main body 110 of the body 100, and the first end portion in the second direction Y of the circuit board 300 is fitted in the circuit board fitting holes 113a, 113b of the main body 110. Consequently, the rear end portions of the contacts 200a come into contact with the electrodes 320a of the circuit board 300 and the rear end portions of the contacts 200b come into contact with the electrodes 320b of the circuit board 300. The rear end portions of the contacts 200a are then soldered to the electrodes 320a of the circuit board 300, and the rear end portions of the contacts 200b are soldered to the electrodes 320b of the circuit board 300. The next step is to prepare the first and second cables 400a, 400b, in which the external insulators are striped to expose distal ends of the plurality of signal lines. The cores of the signal lines are connected by soldering to the electrodes 330a, 330b of the circuit board 300. This is how the contacts 200a, 200b, the circuit board 300, and the first and second cables 400a, 400b are attached to the body 100.

The next step is to prepare the shell 500c formed by press-molding a metal sheet. The first connecting portion 120a of the body 100 is inserted into the shell body 510c of the shell 500c. The second plates 522c, 532c of the first and second contact plates 520c, 530c of the shell 500c are fitted in the upper and lower attaching depressions 117a, respectively, of the main body 110 of the body 100, and the locking projections 118a on the bottom of the attaching depressions 117a are fitted and locked in the locking holes 522c1, 532c1 of the second plates 522c, 532c. The shell 500c is now attached to the body 100 and cover an outer circumference of the first connecting portion 120a.

The next step is to prepare the shell 500b, the release levers 500e, 500f, and the latch pieces 500g, 500h formed by press-molding a metal sheet. The shell 500b is placed over the main body 110 of the body 100 from above, so that the side walls 520b, 530b of the shell 500b abut the upper portions of the opposite surfaces in the first direction X of the main body 110. Simultaneously, the locking projections 116a, 116b of the main body 110 are fitted and locked in the locking holes 521b, 531b of the side walls 520b, 530b. Also, the base plate 510b of the shell 500b abuts and contacts the upper surface of the main body 110, so that the portion on the right side of the slit 513b of the first end portion 511b of the base plate 510b is placed on the second plate 532c of the second contact plate 530c of the shell 500c. This physical contact allows electrical connection between the shell 500b and the shell 500c. Simultaneously, the locking projection 117b of the main body 110 is fitted and locked in the locking hole 514b of the base plate 510b of the shell 500b. The positioning holes 515b in the portion on the left side of the slit 513b in the first end portion 511b of the shell 500b are disposed so as to communicate with the positioning holes 118b of the main body 110. Furthermore, the latch piece 500g is disposed to face with the clearance the first end portion in the first direction X of the second connecting portion 120b, and the latch piece 500h is disposed to face with the clearance the second end portion in the first direction X of the second connecting portion 120b.

The next step is to prepare the shells 500a, 500d formed by press-molding a metal sheet. The second connecting portion 120b of the body 100 is inserted into the shell body 510d of the shell 500d, and the upper plate of the contact plate 530d of the shell 500d is placed on and brought into contact with the left portion of the shell 500b. This physical contact allows electrical connection between the shells 500d, 500a and the shell 500b. Simultaneously, the locking projection 117b of the main body 110 is fitted and locked in the cut-away 531d of the upper plate of the contact plate 530d, and the positioning holes 532d of the upper plate of the contact plate 530d are disposed so as to communicate with the positioning holes 515b of the shell 500b and with the positioning holes 118b of the main body 110. It should be noted that the first and second end portions in the first direction X of the shell body 510d are open. The shell body 510d of such configuration can receive the second connecting portion 120b without interfering with latch pieces 500g, 500h provided near the first and second ends in the first direction X of the second connecting portion 120b. Through the attachment of the shell 500d to the second connecting portion 120b as described above, the base plate 510a of the shell 500a is brought into abutment with the lower surface of the main body 110 of the body 100, and the side walls 520a, 530a of the shell 500a abut the lower portions of the opposite surfaces in the first direction X of the main body 110. The first end portion 511a of the base plate 510a of the shell 500a is placed on and brought into abutment with the second plate 522c of the first contact plate 520c. Consequently, the base plate 510a and the side walls 520a, 530a of the shell 500a, and the base plate 510b and the side walls 520b, 530b of the shell 500b cover the outer circumference of the main body 110, the circuit board 300, and the board-connectable portion of the cable 400. Moreover, the positioning hole 513a of the shell 500a communicates with the positioning hole 119 of the main body 110. The locking projection 119b of the main body 110 is fittingly received and locked in the locking hole 514a of the shell 500a.

The next step is to prepare the first and second resin cases 600a, 600b. The shells 500a, 500b, the main body 110 of the body 100, and the circuit board 300 are placed into the accommodating space of the first resin case 600a. The shell body 510c of the shell 500c and the first connecting portion 120a of the body 100 are inserted into the first depression 621a of the front wall 620a of the first resin case 600a, and the shell body 510d of the shell 500d and the second connecting portion 120b of the body 100 are inserted into the second depression 622a of the front wall 620a. Simultaneously, the flanges 710 of the clamp 700 attached to the first and second cables 400a, 400b are fitted in the slits 651a of the fixing portions 650a of the first resin case 600a, and the first and second cables 400a, 400b are inserted into the depressions 661a, 662a of the lead-out portion 660a of the first resin case 600a. The positioning projection 611a of the first resin case 600a is fitted in the positioning hole 515a of the shell 500a of the shield case 500, and the positioning projection 612a is fitted in the positioning hole 513a of the shell 500a and the positioning hole 119 of the main body 110. Thereafter, the second resin case 600b is attached to the first resin case 600a, so that the operation buttons 631a, 641a of the first resin case 600a are inserted into the loading depressions 631b, 641b of the second resin case 600b. Also, the shells 500a, 500b, the main body 110 of the body 100, and the circuit board 300 are accommodated in the accommodating space of the second resin case 600b. The shell body 510c of the shell 500c and the first connecting portion 120a of the body 100 are inserted into the first depression 621b of the front wall 620b of the second resin case 600b, and the shell body 510d of the shell 500d and the second connecting portion 120b of the body 100 are inserted into the second depression 622b of the front wall 620b. Moreover, the flanges 710 of the clamp 700 is fitted in the slits 651b of the fixing portions 650b of the second resin case 600b. The first and second cables 400a, 400b are inserted into the depressions 661b, 662b of the lead-out portion 660b of the second resin case 600b. Moreover, the positioning projection 611b of the second resin case 600b is fitted in the positioning hole 516b of the shell 500b, and the pair of positioning projections 612b is fitted in the pair of positioning holes 532d of the shell 500d, the positioning holes 515b of the shell 500b, and the positioning holes 118b of the main body 110. The first and second resin cases 600a, 600b now accommodate the shells 500a, 500b, the main body 110 of the body 100, the circuit board 300, and the board-connectable portions of the first and second cables 400a, 400b.

The plug P assembled in the above-described steps may be connected to the receptacle R in the following steps. First, the first connecting portion 120a and the shell body 510c of the shell 500c of the plug P are inserted into the first slot a of the receptacle R, and the second connecting portion 120b and the shell body 510d of the shell 500d are inserted into the second slot p of the receptacle R. Upon the insertion, the inner walls of the second slot p press the claws 520g, 520h of the latch pieces 500g, 500h, so that the latch pieces 500g, 500h are displaced from the initial positions to the inner sides (i.e., toward the first and second ends in the first direction X of the second connecting portion 120b). Consequently, the bent portions of the first end portion 531e and the first end portion 511e of the release lever 500e are elastically deformed, so that the bridge 530e and the arm 520e of the release lever 500e are deformed inward from the initial positions. Simultaneously, the folded-back portion 510f of the release lever 500f is elastically deformed, so that the arm 520f of the release lever 500f is displaced inward from the initial position. Once the claws 520g, 520h of the latch pieces 500g, 500h are fitted in the first and second locking holes of the second slot p, elastic forces of the bent portions of the first end portion 531e and the first end portion 511e of the release lever 500e move the bridge 530e, the arm 520e, and the latch piece 500g back to their initial positions. Similarly, elastic force of the folded-back portion 510f of the release lever 500f moves the arm 520f and the latch piece 500h back to their initial positions. The claws 520g, 520h are now fitted in the first and second locking holes of the second slot p, maintained in a locked state in the first and second locking holes of the second slot 13 (fully-latched state).

Simultaneously, the first connection projection 10a of the receptacle R is inserted into the first connection hole 121a of the first connecting portion 120a, and the contacts 20a of the receptacle R come into contact with the summits of the contacts 200a. Similarly, the second connection projection 10b of the receptacle R is inserted into the second connection hole 121b of the second connecting portion 120b, and the contacts 20b of the receptacle R come into contact with the summits of the contacts 200b. This is how to connect the plug P to the receptacle R. It should be appreciated that the shell bodies 510c, 510d of the shells 500c, 500d come into contact with the shell 30 of the receptacle R and are thereby connected through the shell 30 to a ground line of the circuit board on which the receptacle R is mounted.

The connected plug P may be detached from the receptacle R in the following steps. First, the operation buttons 631a, 641a of the plug P are pressed. The pressed operation button 631a presses the arm 520e of the release lever 500e at the initial position inward, and the pressed operation button 641a presses the arm 520f of the release lever 500f at the initial position inward. Then, the bent portions of the first end portion 531e and the first end portion 511e of the release lever 500e are elastically deformed, and the folded-back portion 510f of the release lever 500f is elastically deformed. Simultaneously, the latch pieces 500g, 500h are displaced inward from the initial positions. Consequently, the claws 520g, 520h come off and get disengaged from the first and second locking holes of the second slot β. The plug P is now ready to be pulled out of the receptacle R.

In the plug P as described above, the shell 500a and the shell 500d are made of a single metal sheet, and the shell 500b, the release levers 500e, 500f, and the latch pieces 500g, 500h are made of a single metal sheet. The plug P is therefore advantageous in reducing the number of components and assembling man-hours. The decreased number of shells also means reduced costs for press work of the shells, and the plug P can be further reduced in cost in this regard. Moreover, as the fourth shell 500d is integrated with the first shell 500a, electrical connection between the shells 500a to 500d can be established with ease, simply by bringing the contact plate 530d of the shell 500d into contact with the first end portion 511b of the shell 500b, bringing the first contact plate 520c of the shell 500c into contact with the first end portion 511a of the shell 500a, and bringing the second contact plate 530c of the shell 500c into contact with the first end portion 511b of the shell 500b. Further advantageously, the shell 500c and the shell 500d independently cover the first connecting portion 120a and the first connecting portion 120b, respectively. As such, the plug P can be connected to a receptacle connecter such as the receptacle R with the first and second slots α, β fully partitioned with the bent portion 31. Furthermore, as the shell 500d is integrated with the shell 500a, the shell 500d is improved in prying resistance.

Moreover, the latch pieces 500g, 500h are arranged on the first and second end sides in the first direction X of the second connecting portion 120b, the release lever 500e lies outside the side wall 520b of the shell 500b with clearance, the release lever 500f lies outside the side wall 530b of the shell 500b with clearance, and the operation buttons 631a, 641a are arranged outside the release levers 500e, 500f. That is, the latch pieces 500g, 500h, the operation buttons 631a, 641a, and the release levers 500e, 500f are arranged along the first direction X (width direction) of the plug P, it is possible to minimize the thickness of the plug P, as compared with a plug having latch pieces, release levers and operation buttons arranged along the third direction Z (i.e., thickness direction). Moreover, in a plug having operation buttons arranged along the thickness direction, if such plug is connected to a receptacle installed in electronic equipment placed on a table or the like, the operation buttons may hit the table. The table may apply external force on the operation buttons, and the external force may cause inadvertent slip-off of latch pieces from the locking holes of the slot. This is in contrast with the plug P with the operation buttons 631a, 641a provided along the width direction, free from concern for inadvertent slip-off of the claws 520g, 520h of the latch pieces 500g, 500h from the first and second locking holes of the second slot β if the plug P hits the table. Still advantageously, the plug P includes connection structures of two types corresponding to the HDMI type D standard and another standard. As such, the other connection structure can supply power for the connection structure (the first connecting portion 120a and the contacts 200a) of the HDMI type D standard that may be used for performing input/output of video or other signals, free from concern for the power consumption of the connection structure for the HDMI type D standard.

The plug P is not limited to the above-described embodiment, but it may be modified in design within the scope of claims. Examples of modifications are described more in detail below.

The body 100 may be attached with the circuit board 300 as in the above-described embodiment, but it may be modified in design as desired, as long as including the main body and the first and second connecting portions projecting from the main body and adjacent to each other in the first direction. In the case where the circuit board 300 is omitted, the cores of the signal lines of the first and second cables 400a, 400b may be connected by soldering directly to the rear end portions of the contacts 200a, 200b. Moreover, the slit 111 may be provided in the main body 110 as in the above-described embodiment or may be omitted. If the slit 111 is omitted, the second end portion 532e of the bridge 530e may be arranged at any position between the first and second connecting portions 120a, 120b (i.e., in a space between the shells 500c and 500d).

The shells 500a, 500b may be of any shapes that can cover the outer circumference of the main body of the body. For example, only one of the shells 500a, 500b has side walls covering opposite sides in the first direction of the main body of the body.

The shell 500d may or may not be configured as in the above embodiment. More particularly, the first and second end portions in the first direction X of the shell body 510d may be opened as in the above embodiment, or it may be of such a structure as to cover the first and second end portions in the first direction X of the second connecting portion 120b. Moreover, the contact plate 530d of the shell 500d may be omitted. In this case, the shells 500a, 500b may be brought into contact with each other, or the shell 500c may be brought into contact with the shells 500a, 500b. Also, the shell 500c may have the first and second contact plates 520c, 530c to contact the shells 500a, 500b as in the above-described embodiment, but the shell 500c only needs to contact at least one of the shells 500a, 500b. The first and second contact plates 520c, 530c and the contact plate 530d may be modified in shape, as long as they are contactable with the contact targets. The joining plate 520d may be of any shape adapted for coupling to the shell 500a.

The shell 500b, the release levers 500e, 500f and the latch pieces 500g, 500h may or may not be made of a sheet of metal plate. For examples, the release levers 500e, 500f and the latch pieces 500g, 500h may be separately provided from the shell 500b, and the release levers 500e, 500f and the latch pieces 500g, 500h may be provided in the shell 500a. Alternatively, it is possible to omit the release levers 500e, 500f and only provide the latch pieces 500g, 500h integrally with the shell 500b or the shell 500a. It is also possible to omit the release levers 500e, 500f and provide the latch pieces 500g, 500h separately from the shells 500a, 500b.

The first and second locking pieces may or may not be the latch pieces 500g, 500h having the claws 520g, 520h. If claws are provided in a mating connector, locking holes for locking the claws may be provided at the front ends of the first and second locking pieces. The latch pieces 500g, 500h of the above embodiment is configured such that their claws 520g, 520h are fitted in the first and second locking holes of the receptacle R and are locked in the fully-latched state. Alternatively, the latch pieces may be configured such that their claws are locked in the locking holes in a half-latched state. Moreover, the first and second locking pieces may be omitted if deemed unnecessary.

The release lever 500e of the above embodiment includes the folded-back portion 510e, the arm 520e, and the bridge 530e. However, the release lever 500e may be modified in design, as long as it connects between the shell 500a or 500b and the first locking piece, lies with a clearance from the first side wall of the shell 500a or 500b, and can be displaced toward the first side wall. Accordingly, the release lever 500e may be provided separately from the shell 500b and the latch piece 500g and attached to the shell 500b and the latch piece 500g. The folded-back portion 510e may be provided continuously to the second end portion 512b of the base 510b of the shell 500b, or it may be provided continuously to the second end portion in the second direction Y of the side wall 520b of the shell 500b. The folded-back portion 510e may also be provided continuously to the shell 500a.

The release lever 500f of the above embodiment has the folded-back portion 510f and the arm 520f. However, the release lever 500f may be modified in design, as long as it connects between the shell 500a or 500b and the second locking piece, lies with a clearance from the second side wall of the shell 500a or 500b, and can be displaced toward the second side wall. Accordingly, the release lever 500f may be provided separately from the shell 500b and the latch piece 500h and attached to the shell 500b and the latch piece 500h. The folded-back portion 510f may be provided continuously to the second end portion of the side wall 530b of the shell 500b, or alternatively it may be provided continuously to the second end portion 512b of the base 510b of the shell 500b. The folded-back portion 510f may also be provided continuously to the shell 500a.

The plug P of the invention may or may not include the first and second cables 400a, 400b. The cables may be omitted if the present invention is applied to a receptacle connector as described later.

The first resin case 600a of the above embodiment has the operation buttons 631a, 641a. However, the operation buttons 631a, 641a may be omitted if the release levers are omitted as described above. Moreover, in the case where the present invention is applied to a receptacle connector, the first and second resin cases 600a, 600b may be omitted.

The materials, shapes, numbers, dimensions etc. of the respective elements of the plug connector of the embodiment have been described by way of example only, and they may be modified in design in any manner as long as they provide similar functions. The present invention can be applied not only to plug connectors but also to receptacle connectors. Moreover, the connector of the present invention is connectable to a mating connector with the first and second slots completely partitioned, but it may also be connected to a mating connector with the first and second slots not completely partitioned.

### REFERENCE SIGNS LIST

P plug

100 body
110 main body
   111 slit
120a first connecting portion
120b second connecting portion

200a contact

200b contact

300 circuit board

400a first cable

400b second cable

500 shield case
500a shell (first shell)
   510a base plate (base)
   520a side wall (first side wall)
   530a side wall (second side wall)
500b shell (second shell)
   510b base plate (base)
   520b side wall (first side wall)
   530b side wall (second side wall)
500c shell (third shell)
   510c shell body
   520c first contact plate (contact portion)
   530c second contact plate (contact portion)
500d shell (fourth shell)
   510d shell body
   520d joining plate (joining portion)
   530d contact plate (contact portion)
500e release lever (first release lever)
   510e folded-back portion (first folded-back portion)
   520e arm (first arm)
   530e bridge
500f release lever (second release lever)
   510f folded-back portion (second folded-back portion)
   520f arm (second arm)
500g latch piece (first locking piece)
500h latch piece (second locking piece)

600a first resin case (first case)
631a operation button (first operation button)
641a operation button (second operation button)

600b second resin case (second case)

X first direction

Y second direction

Z third direction

1. A shield case to cover a body, the body having a main body and first and second connecting portions projecting from the main body and lying adjacent to each other along a first direction, the shield case comprising:
first and second shells, having conductive properties and being adapted to cover an outer circumference of the main body;
a third shell, having a conductive property and being adapted to cover the first connecting portion; and
a fourth shell, having a conductive property and being adapted to cover the second connecting portion, wherein
the third shell is in contact with at least one of the first and second shells,
the first or fourth shell is in contact with the second shell, and
the fourth shell is provided integrally with the first shell and is adjacent to the third shell along the first direction.

2. A shield case to cover a body, the body having a main body and first and second connecting portions projecting from the main body and lying adjacent to each other along a first direction, the shield case comprising:
first and second shells, having conductive properties and being adapted to cover an outer circumference of the main body;
a third shell, having a conductive property and being adapted to cover the first connecting portion; and
a fourth shell, having a conductive property and being adapted to cover the second connecting portion, wherein
the third shell is in contact with the first and second shells, and
the fourth shell is provided integrally with the first shell and is adjacent to the third shell along the first direction.

3. The shield case according to claim 1, wherein
the first and second shells each include a base, the base including first and second ends in the first direction and first and second ends in a second direction perpendicular to the first direction,
the third shell includes:
a shell body of tuboid shape, adapted to cover the first connecting portion; and
a contact portion, being provided in the shell body and in contact with the first end in the second direction of the base of at least one of the first and second shells, and
the fourth shell includes:
a shell body, adapted to cover the second connecting portion; and
a joining portion, joining the shell body of the forth shell and the first end in the second direction of the base of the first shell.

4. The shield case according to claim 3, wherein
the main body of the body includes first and second surfaces that are opposed along a third direction perpendicular to the first and second directions,
at least one of the first and second shells further includes first and second side walls, the first and second side walls standing upright at the first and second ends in the first direction of the base of the at least one of the first and second shells,
the base of the first shell is abuttable on the first surface of the main body, and
the base of the second shell is abuttable on the second surface of the main body.

5. The shield case according to claim 3, wherein the fourth shell further includes a contact portion provided at the shell body of the forth shell, the contact portion being in contact with the first end in the second direction of the second shell.

6. The shield case according to claim 1, further comprising:
a first locking piece, provided on one side in the first direction of the fourth shell; and
a second locking piece, provided on the other side in the first direction of the fourth shell.

7. The shield case according to claim 2, further comprising:
a first locking piece, provided on one side in the first direction of the fourth shell; and
a second locking piece, provided on the other side in the first direction of the fourth shell.

8. The shield case according to claim 6, wherein the first and second locking pieces are provided integrally with the first or second shell.

9. The shield case according to claim 7, wherein the first and second locking pieces are provided integrally with the first or second shell.

10. The shield case according to claim 6, further comprising:
a first release lever, connecting between the first or second shell and the first locking piece; and
a second release lever, connecting between the first or second shell and the second locking piece, wherein
the first or second shell includes first and second ends in the first direction, first and second ends in a second direction perpendicular to the first direction, and first and second side walls provided at the first and second ends in the first direction, and
the first and second release levers are arranged with clearances from the first and second side walls and are movable toward the first and second side walls.

11. The shield case according to claim 7, further comprising:
a first release lever, connecting between the first or second shell and the first locking piece; and
a second release lever, connecting between the first or second shell and the second locking piece, wherein
the first or second shell includes first and second ends in the first direction, first and second ends in a second direction perpendicular to the first direction, and first and second side walls provided at the first and second ends in the first direction, and
the first and second release levers are arranged with clearances from the first and second side walls and are movable toward the first and second side walls.

12. The shield case according to claim 10, wherein
the second release lever includes:
a second folded-back portion, being provided integrally with the second end in the second direction of the first or second shell and folded back toward the first end in the second direction thereof; and
a second arm, being provided integrally with the second folded-back portion and is disposed with a clearance from the second side wall, the second arm including first and second ends in the second direction,
the first release lever includes:
a first folded-back portion, being provided integrally with the second end in the second direction of the first or second shell and folded back toward the first end in the second direction thereof,
a first arm, being provided integrally with the first folded-back portion and is disposed with a clearance from the first side wall; and
a bridge, extending from the first arm into a space formed between the third and fourth shells, the bridge including a first end provided integrally with the first arm and a second end disposed in the space, and
the second locking piece is provided integrally with the first end of the second arm, and the first locking piece is provided integrally with the second end of the bridge.

13. The shield case according to claim 11, wherein
the second release lever includes:
a second folded-back portion, being provided integrally with the second end in the second direction of the first or second shell and folded back toward the first end in the second direction thereof; and
a second arm, being provided integrally with the second folded-back portion and is disposed with a clearance from the second side wall, the second arm including first and second ends in the second direction,
the first release lever includes:
a first folded-back portion, being provided integrally with the second end in the second direction of the first or second shell and folded back toward the first end in the second direction thereof,
a first arm, being provided integrally with the first folded-back portion and is disposed with a clearance from the first side wall; and
a bridge, extending from the first arm into a space formed between the third and fourth shells, the bridge including a first end provided integrally with the first arm and a second end disposed in the space, and
the second locking piece is provided integrally with the first end of the second arm, and the first locking piece is provided integrally with the second end of the bridge.

14. The shield case according to claim 10, wherein
the body includes a slit communicating with a space between the third and fourth shells,
the second release lever includes:
a second folded-back portion, being provided integrally with the second end in the second direction of the first or second shell and folded back toward the first end in the second direction thereof; and
a second arm, being provided integrally with the second folded-back portion and is disposed with a clearance from the second side wall, the second arm including first and second ends in the second direction,
the first release lever includes:
a first folded-back portion, being provided integrally with the second end in the second direction of the first or second shell and folded back toward the first end in the second direction thereof,
a first arm, being provided integrally with the first folded-back portion and is disposed with a clearance from the first side wall; and
a bridge, extending from the first arm into the slit, the bridge including a first end provided integrally with the first arm and a second end disposed in the slit, and
the second locking piece is provided integrally with the first end of the second arm, and the first locking piece is provided integrally with the second end of the bridge.

15. The shield case according to claim 11, wherein
the body includes a slit communicating with a space between the third and fourth shells,
the second release lever includes:
a second folded-back portion, being provided integrally with the second end in the second direction of the first or second shell and folded back toward the first end in the second direction thereof; and
a second arm, being provided integrally with the second folded-back portion and is disposed with a clearance from the second side wall, the second arm including first and second ends in the second direction,
the first release lever includes:
a first folded-back portion, being provided integrally with the second end in the second direction of the first or second shell and folded back toward the first end in the second direction thereof,
a first arm, being provided integrally with the first folded-back portion and is disposed with a clearance from the first side wall; and
a bridge, extending from the first arm into the slit, the bridge including a first end provided integrally with the first arm and a second end disposed in the slit, and
the second locking piece is provided integrally with the first end of the second arm, and the first locking piece is provided integrally with the second end of the bridge.

16. The shield case according to claim 1, the body including a locking projection, wherein
a cut-away or a locking hole for locking the locking projection is formed in at least one of the first, second, third and fourth shells.

17. The shield case according to claim 2, the body including a locking projection, wherein
a cut-away or a locking hole for locking the locking projection is formed in at least one of the first, second, third and fourth shells.

18. The shield case according to claim 1, the body including a locking hole, wherein
a locking projection adapted to be locked in the locking hole is provided on at least one of the first, second, third and fourth shells.

19. The shield case according to claim 2, the body including a locking hole, wherein
a locking projection adapted to be locked in the locking hole is provided on at least one of the first, second, third and fourth shells.

20. The shield case according to claim 6, wherein
the fourth shell includes first and second end portions in the first direction, the first and second end portions including openings, and
the first and second locking pieces are adapted to face first and second ends in the first direction of the second connecting portion of the body.

21. The shield case according to claim 7, wherein
the fourth shell includes first and second end portions in the first direction, the first and second end portions including openings, and
the first and second locking pieces are adapted to face first and second ends in the first direction of the second connecting portion of the body.

22. A connector comprising:
the shield case according to claim 1;
the body, including the main body and the first and second connecting portions projecting from the main body and lying adjacent to each other along the first direction;
a plurality of first contacts, arrayed in the first and connecting portion; and
a plurality of second contacts, arrayed in the second and connecting portion.

23. A connector comprising:
the shield case according to claim 2;
the body, including the main body and the first and second connecting portions projecting from the main body and lying adjacent to each other along the first direction;
a plurality of first contacts, arrayed in the first and connecting portion; and
a plurality of second contacts, arrayed in the second and connecting portion.

24. The connector according to claim 22 being a plug connector, further comprising:
a circuit board, provided in the main body of the body and connected to the first and second contacts;
a cable, including a board-connectable portion adapted to be connected to the circuit board; and
first and second cases having insulating properties, the first and second cases in combination being adapted to cover the first and second shells, wherein
the first and second shells of the shield case are adapted to cover, in addition to the main body of the body, the outer circumference of the circuit board and the board-connectable portion of the cable.

25. The connector according to claim 23 being a plug connector, further comprising:
a circuit board, provided in the main body of the body and connected to the first and second contacts;
a cable, including a board-connectable portion adapted to be connected to the circuit board; and
first and second cases having insulating properties, the first and second cases in combination being adapted to cover the first and second shells, wherein
the first and second shells of the shield case are adapted to cover, in addition to the main body of the body, the outer circumference of the circuit board and the board-connectable connectable portion of the cable.

26. A connector comprising:
the shield case according to claim 10;
the body, including the main body and the first and second connecting portions projecting from the main body and lying adjacent to each other along the first direction;
a plurality of first contacts, arrayed in the first and connecting portion; and
a plurality of second contacts, arrayed in the second and connecting portion.

27. A connector comprising:
the shield case according to claim 11;
the body, including the main body and the first and second connecting portions projecting from the main body and lying adjacent to each other along the first direction;
a plurality of first contacts, arrayed in the first and connecting portion; and
a plurality of second contacts, arrayed in the second and connecting portion.

28. The connector according to claim 26 being a plug connector, further comprising:
a circuit board, provided in the main body of the body and adapted for connection with the first and second contacts;
a cable, including a board-connectable portion adapted to be connected to the circuit board; and
first and second cases having insulating properties, the first and second cases in combination being adapted to cover the first and second shells, wherein
the first and second shells of the shield case are adapted to cover, in addition to the main body of the body, the outer circumference of the circuit board and the board-connectable portion of the cable, and
the first or second case includes first and second operation buttons to displace the first and second release levers toward the first and second side walls of the first or second shell.

29. The connector according to claim 27 being a plug connector, further comprising:
a circuit board, provided in the main body of the body and adapted for connection with the first and second contacts;
a cable, including a board-connectable portion adapted to be connected to the circuit board; and
first and second cases having insulating properties, the first and second cases in combination being adapted to cover the first and second shells, wherein
the first and second shells of the shield case are adapted to cover, in addition to the main body of the body, the outer circumference of the circuit board and the board-connectable portion of the cable, and
the first or second case includes first and second operation buttons to displace the first and second release levers toward the first and second side walls of the first or second shell.
